(19) United States
(12) Patent Application Publication
(10) Pub. No.: US 2014/0369456 A1
(43) Pub. Date: Dec. 18, 2014

(54) ROD MOVEMENT DIAGNOSTICS FOR NUCLEAR POWER PLANT USING ADVANCED DATA FITTING

(71) Applicant: Analysis and Measurement Services Corporation, Knoxville, TN (US)

(72) Inventors: Samuel D. Caylor, Knoxville, TN (US); Jacob R. McCulley, Knoxville, TN (US); Gregory W. Morton, Knoxville, TN (US); Hashem M. Hashemian, Knoxville, TN (US)

(21) Appl. No.: 13/920,631

(22) Filed: Jun. 18, 2013

(51) Int. Cl. G21C 17/00

(52) U.S. Cl. CPC G21C 17/00
USPC 376/259; 376/245

(57) ABSTRACT

Systems and methods of monitoring rod control systems of nuclear power plants, including: measuring a particular signal applied to at least one coil of a rod movement mechanism at one or more predetermined times relative to an initial energizing of a mechanism coil; comparing the measured signal to a reference signal parameter, and determining if the measured signal deviates from the reference signal parameter by a predetermined amount to indicate degradation of the rod control system.

### FIELD OF INVENTION

The present application relates generally to reactor control systems, and more particularly relates to monitoring operation of rod control systems to verify proper movement of control rods in nuclear power plants.

### BACKGROUND

In a nuclear Pressurized Water Reactor (PWR), the power level of the reactor is controlled by inserting and retracting control rods and/or shutdown rods, in a reactor core.

Current designs of many nuclear power plants are equipped with control and shutdown rods which are inserted and withdrawn from the reactor core to control the reactivity by absorbing neutrons. Specifically, in Pressurized Water Reactors (PWRs), the movement of each of these rods is facilitated by an electromechanical magnetic jack mechanism located atop the reactor vessel. Two such rod control systems that operate on this principle include the Control Rod Drive Mechanism (CRDM) and Control Element Drive Mechanism (CEDM). Both of these mechanisms consist of a set of coils that provide precise vertical movement to the rod by sequentially inducing a magnetic field in the coils to operate the mechanical parts of the system. The magnetic flux provides the energy needed to hold, insert, or withdraw the rod from the reactor core.

Efforts regarding such systems have led to continuing developments to improve their versatility, practicality and efficiency. For example, several diagnostic techniques have been developed to verify proper rod movement from the coil current traces due to increasing occurrences of slipped and stuck rods throughout the nuclear industry.

### BRIEF SUMMARY

Example embodiments of the present general inventive concept provide systems and methods of verifying proper movement of control rods in nuclear power plants.

Additional features and embodiments of the present general inventive concept will be set forth in part in the description which follows and, in part, will be obvious from the description, or may be learned by practice of the present general inventive concept.

Example embodiments of the present general inventive concept can be achieved by providing a method of monitoring a rod control system of a nuclear power plant, including measuring a control signal applied to at least one coil of a rod movement mechanism at one or more predetermined times relative to an initial rod movement request signal, comparing the measured control signal to a reference signal parameter, and determining if the measured control signal deviates from the reference signal parameter by a predetermined amount to indicate impairment of the rod control system.

Example embodiments of the present general inventive concept can also be achieved by providing a system to monitor rod movement signals of a rod control system of a nuclear power plant, including a measurement from one or more control signals applied to at least one coil of a rod movement mechanism, and a controller to acquire a measured control signal at one or more predetermined times relative to an initial rod movement request signal, to compare the measured control signal to a reference signal parameter, and to determine if the measured control signal deviates from the reference signal parameter by a predetermined amount to indicate impairment of the rod control system.

The system can include an output unit to output a signal when the measured control signal deviates from the reference signal parameter by one or more predetermined amounts.

### BRIEF DESCRIPTION OF THE DRAWINGS

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 is a schematic block diagram of a rod control and position system for a pressurized water reactor according to an example embodiment of the present general inventive concept;

FIG. 2 is a cross sectional block diagram of a Control Rod Drive Mechanism (CRDM) system according to an example embodiment of the present general inventive concept;

FIG. 3 is a cross sectional block diagram of a Control Element Drive Mechanism (CEDM) according to an example embodiment of the present general inventive concept;

FIG. 4 is a an example of CRDM currents for a withdrawal sequence according to an example embodiment of the present general inventive concept;

FIG. 5 is a diagram of example improper moveable gripper latching signals according to an example embodiment of the present general inventive concept;

FIG. 6 illustrates diagrams of example improper rod movement signals according to an example embodiment of the present general inventive concept;

FIG. 7 illustrates diagrams of example rod movement fitting methods according to an example embodiment of the present general inventive concept and

FIG. 8 illustrates an equivalent electrical circuit of a CRDM coil according to an example embodiment of the present general inventive concept.

### DETAILED DESCRIPTION

Reference will now be made to example embodiments of the present general inventive concept, examples of which are illustrated in the accompanying drawings and illustrations. The example embodiments are described herein in order to explain the present general inventive concept by referring to the figures.

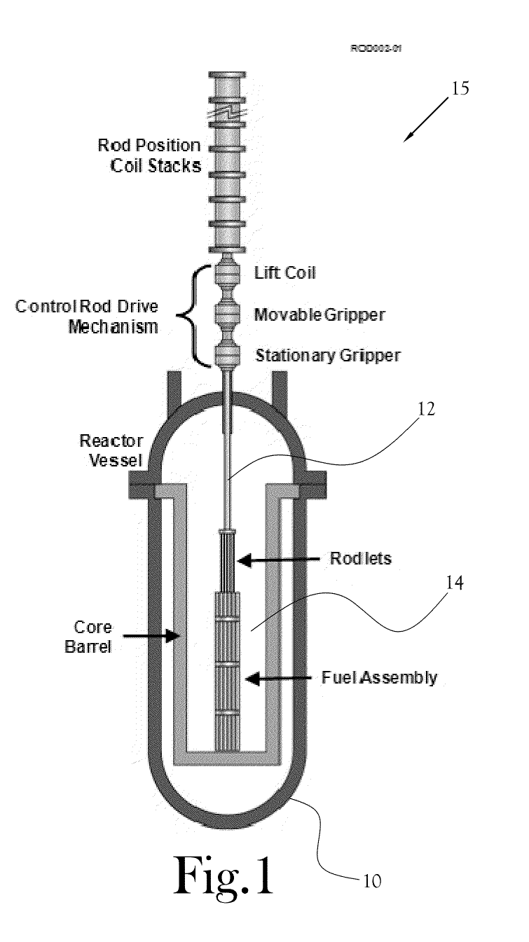

FIG. 1 is a schematic block diagram of a rod control system 15 for a Pressurized Water Reactor according to an example embodiment of the present general inventive concept. Referring to FIG. 1, the power level of the reactor 10 is controlled by inserting and retracting control rods 12 (which may include the shutdown rods) into the reactor core 14 to control the reactivity by absorbing neutrons. Movement of each rod may be facilitated by its own electromechanical magnetic jack mechanism located atop a reactor vessel referred to as a rod control system.

In the embodiment of FIG. 1, the control rods are moved by a Control Rod Drive Mechanism (CRDM) which uses electromechanical jacks to raise or lower the control rods in increments. The CRDM may include a lift coil, a moveable coil, and a stationary coil controlled by a Rod Control System (RCS), and a ferromagnetic drive rod coupled to the control rod to move within a pressure housing. The drive rod may include a number of circumferential grooves at single step intervals that define a range of movement for the control rod. An example step interval may be ⅝ inch. An example drive rod may contain approximately 231 steps, which may vary.

The RCS may include a logic cabinet and a power cabinet. The logic cabinet may receive manual demand signals from an operator or automatic demand signals from a reactor control and provides command signals needed to operate shutdown and control rods according to a predetermined schedule. The power cabinet provides a programmed current. The rod movement demand, generated by either the operator or the reactor control system, is received and processed by the cabinet logic. The logic cabinet then controls the power switching circuitry that is responsible for the motion of the rod control mechanism. There are currently three different power levels that the switching circuitry provides to the drive mechanism. These power levels include the ‘High’ state, which is used to quickly energize the coil, ‘Reduced’, which is used to maintain the energized state, and ‘Low’, which is used for the coil in the off state. The logic cabinet is responsible for providing the sequence at which these power levels should be applied to the coils for the desired rod movement.

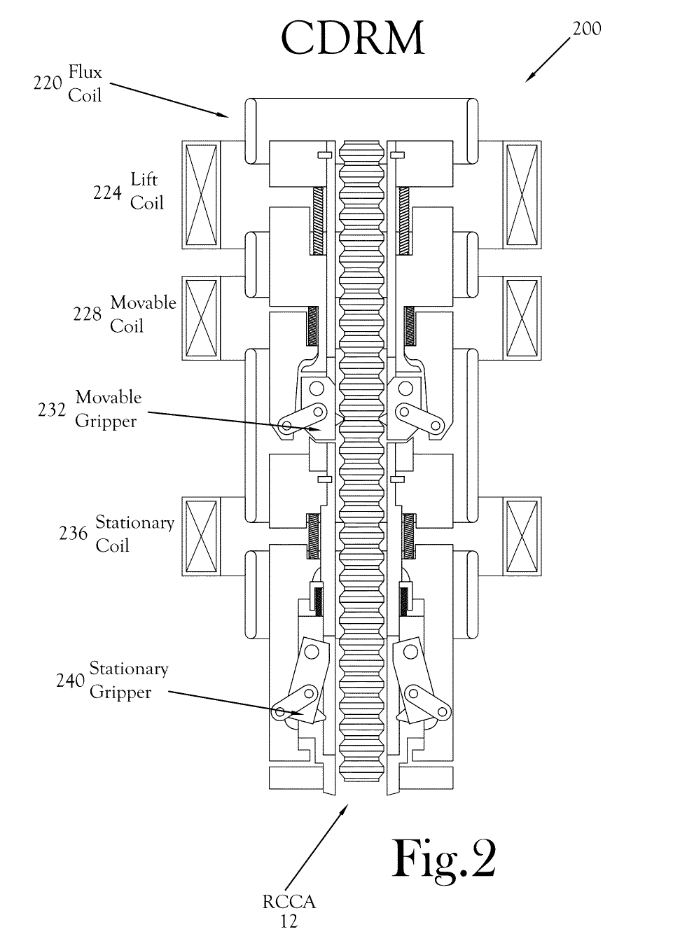

FIG. 2 is a cross sectional block diagram of a Control Rod Drive Mechanism (CRDM) system according to an example embodiment of the present general inventive concept. As illustrated in FIG. 2, an example CRDM comprises three electric coils (Lift, Movable and Stationary) and two electromagnetic jacks with grippers (Movable and Stationary). The drive rod is grooved which allows the grippers to engage and support the weight of the rod. These grooves allow the mechanism to insert and withdraw the rod in ⅝″ steps. A moveable gripper mechanically engages the grooves of a drive rod when its coil is energized, and disengages from the drive rod when the coil is de-energized. Energizing a lift coil raises the moveable gripper and the associated control rod if the moveable coil is energized by one step. Energizing the moveable coil and de-energizing the lift coil moves the control rod down one step. Similarly, when energized, a stationary gripper engages the drive rod to maintain the position of the control rod and, when de-energized, disengages from the drive rod to allow the control rod to move.

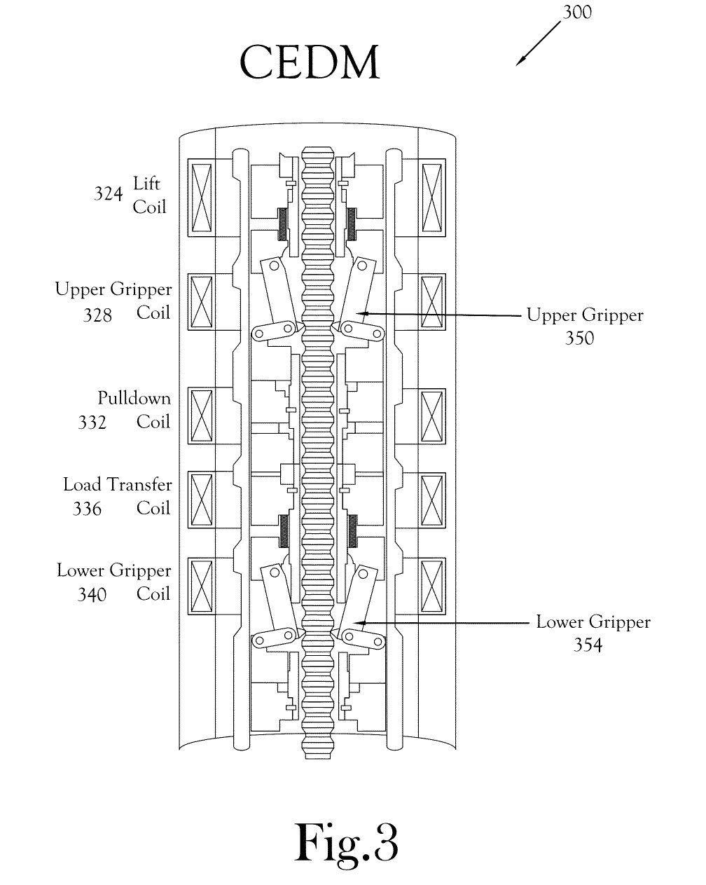

FIG. 3 is a cross sectional block diagram of a Control Element Drive Mechanism (CEDM) according to an example embodiment of the present general inventive concept. As illustrated in FIG. 3, an example CEDM design comprises five electric coils (Lift, Upper Gripper, Pull down, Load Transfer, and Lower Gripper) and two electromagnetic jacks with grippers (Upper and Lower). The drive rod for this system is grooved to allow the rod to insert or withdraw from the reactor core in ¾″ steps when the coils are energized in a particular sequence. The sequencing is established by the logic cabinet through a set of current orders which are provided to the power cabinet firing and regulation cards for low, reduced, or full levels of current to be applied to the coils.

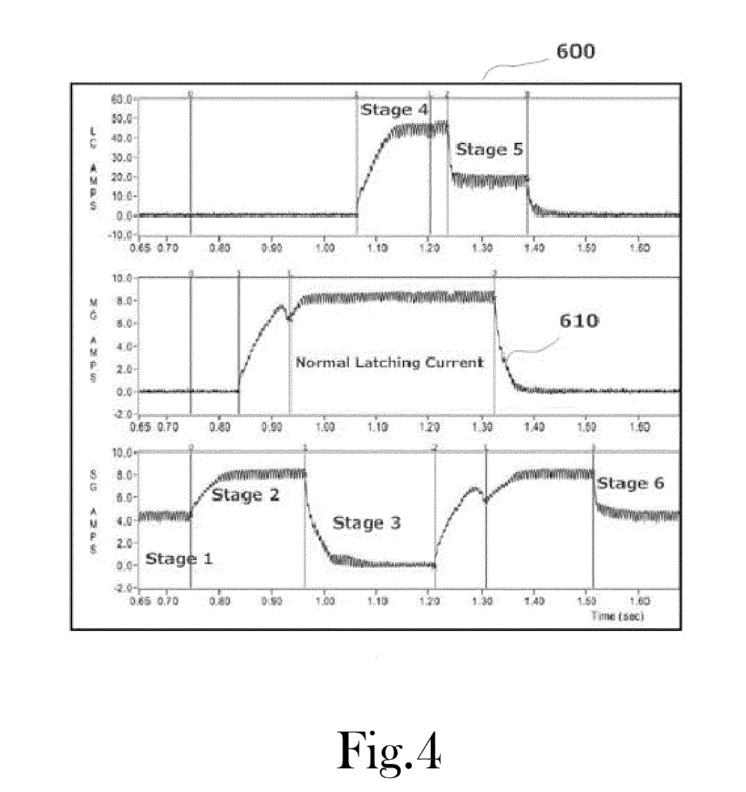

FIG. 4 is an example of CRDM currents for a withdrawal sequence according to an example embodiment of the present general inventive concept. As illustrated in FIG. 4, the coil current data embodies information that can be used to determine proper rod movement and operation. For example, the latching of the stationary and moveable gripper can be confirmed in the coil current data. A rod latching problem could result in a rod slipping or dropping causing the step count in the control room to become unreliable.

The current diagram 600 shows a normal current 610 trace when the rod is withdrawn from a reactor vessel as requested from control signals. Referring to FIG. 4, during a Stage 1, a Stationary Gripper (SG) coil is energized to a reduced current, wherein the SG is the only gripper supporting the rod shaft. In a Stage 2, the SG coil is energized to full, while a Moveable Gripper (MG) coil energizes and latches to the rod shaft. In a Stage 3, the SG coil discharges to an inactive state so that the rod load is transferred completely to the MG. In a Stage 4, the Lift Coil (LC) is energized to full until the rod shaft is lifted a predetermined amount. In a Stage 5, the LC is reduced until the SG coil energizes and latches the gripper again. In a Stage 6, once the SG is latched, the LC and MG disengage, the SG coil discharges to reduced current and the CRDM is returned to Stage 1.

FIG. 5 is a diagram of example improper moveable gripper latching signals according to an example embodiment of the present general inventive concept. As illustrated in FIG. 5, in addition to timing and sequencing, the coil current data holds much more information concerning proper rod movement and operation, and the latching of the stationary and moveable gripper can be confirmed in the coil current data. This is important as a latching problem could result in a rod slipping or dropping causing the step count in the control room to become unreliable.

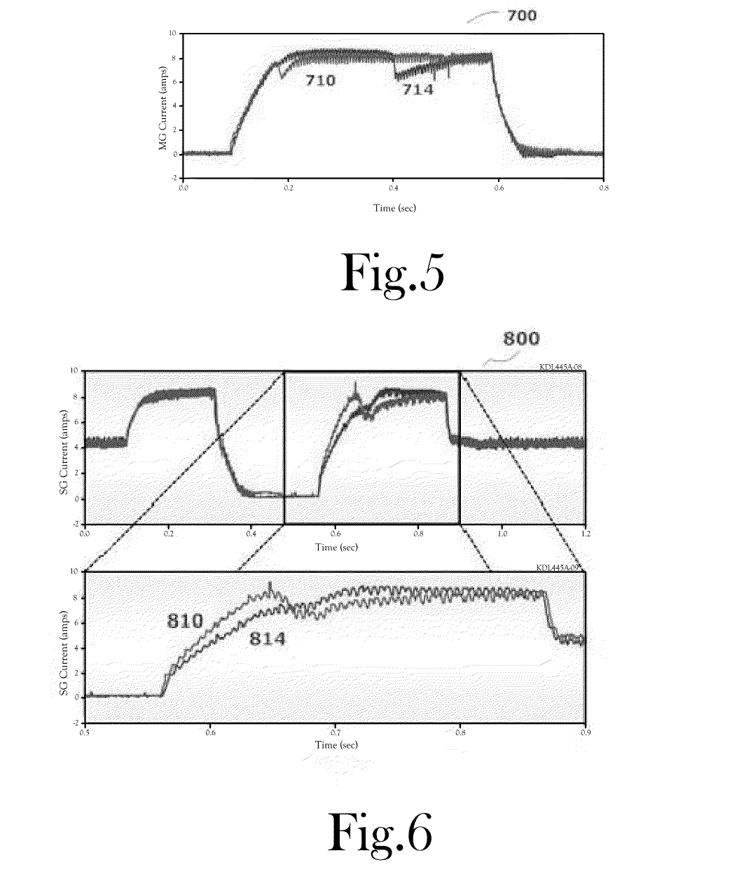

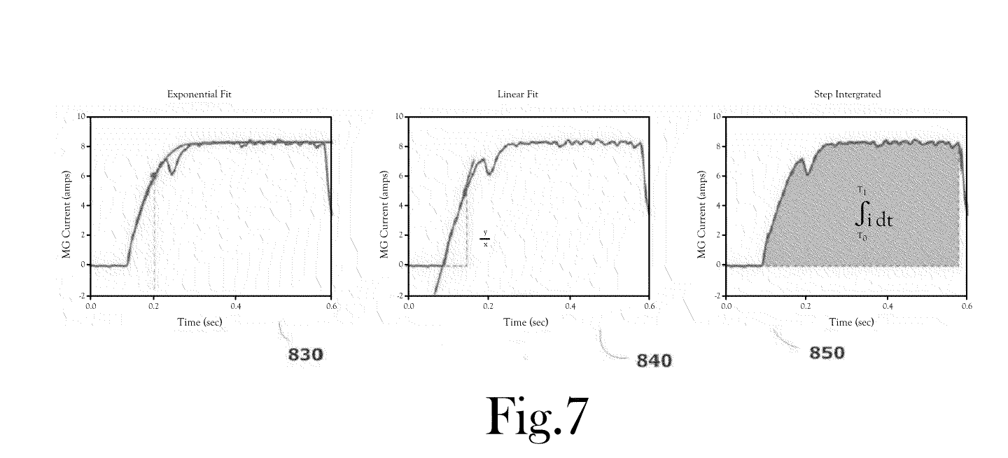

FIG. 6 illustrates diagrams of example improper rod movement signals according to an example embodiment of the present general inventive concept. As illustrated in FIG. 6, a rod has become temporarily immovable. In this figure, two stationary coil traces collected on the same rod are shown. The trace 814 shows the stuck rod and the\ trace 810 shows the rod right after the problem was resolved. To help diagnose this problem, and any other issues with CRDM loading, example methods were developed to determine proper rod movement, examples of which are illustrated in FIG. 7.

FIG. 7 illustrates diagrams of example rod movement fitting methods according to an example embodiment of the present general inventive concept. An example method 830 applies a simple exponential fit to the current traces and calculates a response metric of the CRDM to the rod movement request. Another method 840 applies a linear fit to the rise of the current trace, and the slope is used as an indication of proper rod movement. Another method 850 calculates the integral of the current from the time the current goes high until it returns to the low or reduced state. These example methods produced a useful metric for determining rod movement problems, and the results were very accurate from step to step with a significant change noticed when a problem did exist. Other known or later developed methods could also be implemented without departing from the broader scope and spirit of the present general inventive concept.

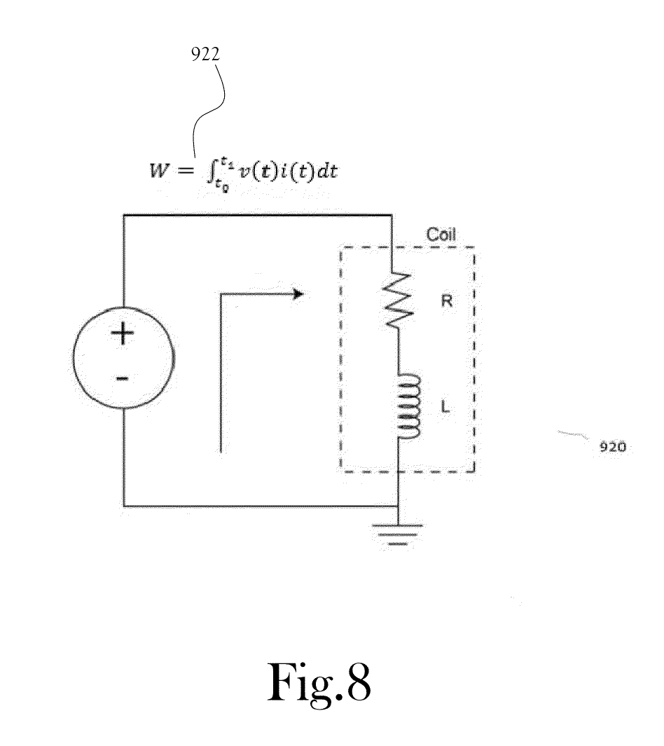

FIG. 8 provides an example equivalent electrical circuit of a CRDM coil embodiment according to an example embodiment of the present general inventive concept. The amount work (W) delivered to a coil over a period of time can be calculated using equation 922. In an example, the work can be calculated over a rod movement sequence to detect changes in the amount of energy needed to move the rod. The examples described herein provide a metric which may be utilized to diagnose rod movement problems because the calculation results may be predictable from step to step wherein a significant variation from normal may be noticed because a problem, such improper rod movement, exists. Changes in the level of work can detect problems with the mechanism.

An example method of monitoring a rod control system of a nuclear power plant, comprises: measuring an input to and/or output signal from at least one coil of a rod movement mechanism at one or more predetermined times relative to an initial energizing of a mechanism coil; calculating a signal parameter from the measured signal and comparing the measured signal to a reference signal parameter; and determining if the calculated parameter deviates from the reference signal parameter by a predetermined amount to indicate impairment of the rod control system. Example methods provide the reference signal parameter is based on at least one of the following: an ideal exponential curve; an ideal linear curve; the integral of a reference signal curve over a predetermined time interval and a work calculation from a reference rod movement mechanism input and output.

An example system to monitor rod movement signals of a rod control system of a nuclear power plant, comprises a system to measure one or more signals applied to at least one coil of a rod movement mechanism and a controller to acquire a measured signal at one or more predetermined times relative to energizing of a mechanism coil, to compare the measured signal to a reference signal parameter, and to determine if the measured signal deviates from the reference signal parameter by a predetermined amount to indicate impairment of the rod control system. An example system might further comprise an output unit to output a signal when the measured signal deviates from the reference signal parameter by one or more predetermined amounts. Example systems provide the reference signal parameter is based on at least one of the following: an ideal exponential curve; an ideal linear curve; a work calculation from the reference rod movement mechanism input and output and the integral of a reference signal curve over a predetermined time interval.

While embodiments of the present general inventive concept are described herein, it is not the intention of the applicant to restrict or in any way limit the scope of the appended claims to such detail. Additional modifications will readily appear to those skilled in the art. The present general inventive concept in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A method of monitoring a rod control system of a nuclear power plant, comprising:
measuring an input to and/or output signal from at least one coil of a rod movement mechanism at one or more predetermined times relative to an initial energizing of a mechanism coil;
calculating a signal parameter from the measured signal and comparing the measured signal to a reference signal parameter; and
determining if the calculated parameter deviates from the reference signal parameter by a predetermined amount to indicate impairment of the rod control system.

2. A method in accordance with claim 1, wherein the reference signal parameter is based on an ideal exponential curve.

3. A method in accordance with claim 1, wherein the reference signal parameter is based on an ideal linear curve.

4. A method in accordance with claim 1, wherein the reference signal parameter comprises the integral of a reference signal curve over a predetermined time interval.

5. A method in accordance with claim 1, wherein the reference signal parameter is based on a work calculation from a reference rod movement mechanism input and output.

6. A system to monitor rod movement signals of a rod control system of a nuclear power plant, comprising:
a system to measure one or more signals applied to at least one coil of a rod movement mechanism; and
a controller to acquire a measured signal at one or more predetermined times relative to energizing of a mechanism coil, to compare the measured signal to a reference signal parameter, and to determine if the measured signal deviates from the reference signal parameter by a predetermined amount to indicate impairment of the rod control system.

7. The system of claim 6, further comprising:
an output unit to output a signal when the measured signal deviates from the reference signal parameter by one or more predetermined amounts.

8. The system of claim 6, wherein the reference signal parameter is based on an ideal exponential curve.

9. The system of claim 6, wherein the reference signal parameter is based on an ideal linear curve.

10. A system of claim 6, wherein the reference signal parameter is based on a work calculation from the reference rod movement mechanism input and output.

11. The system of claim 6, wherein the reference signal parameter is based on the integral of a reference signal curve over a predetermined time interval.
